(19) United States
(12) Patent Application Publication
(10) Pub. No.: US 2017/0249597 A1
(43) Pub. Date: Aug. 31, 2017

(54) INTERACTIVE METHODS AND SYSTEMS TO SCHEDULE ACTIVITIES

(71) Applicant: 6Crickets, Inc., Bellevue, WA (US)

(72) Inventor: Helen J. Wang, Bellevue, WA (US)

(73) Assignee: 6Crickets, Inc., Bellevue, WA (US)

(21) Appl. No.: 15/442,963

(22) Filed: Feb. 27, 2017

Related U.S. Application Data
(60) Provisional application No. 62/299,746, filed on Feb. 25, 2016.

(51) Int. Cl. G06Q 10/10; G09B 5/00; G06Q 50/20

(52) U.S. Cl. CPC G06Q 10/1095; G06Q 50/205; G09B 5/00

(57) ABSTRACT

This disclosure is directed to systems and methods that enable users to schedule activities offered by multiple different enrichment providers. The systems and methods allow enrichment providers a place to market and offer activities to users, sifts through numerous activities offered by the enrichment providers to determine the activities that satisfy user criteria, such as date ranges, age, interest, and location. The user may also view the identified activities and create schedules of activities for one or more students, simultaneously register with the enrichment providers that offer the selected activities, and pay for selected activities.

### CROSS-REFERENCE TO RELATED APPLICATION

This application claims priority from Provisional Application 62/299,746, filed Feb. 25, 2016.

### BACKGROUND

In recent years, the demand by parents for education enrichment programs has dramatically increased. This strong demand has encouraged an increase in quantity, quality, and variety of enrichment programs offered by enrichment providers. For example, tens of thousands of enrichment providers across the United States offer a wide variety of education enrichment programs including drama, art, chess, ballet, music, mathematics, writing, computer programming, three-dimensional modeling and printing, public speaking, and wilderness adventures, just to name a few.

Enrichment providers offer their enrichment programs using a variety of different media. Parents may spend hours and days searching and planning extracurricular enrichment programs for their children. For example, each enrichment provider may have a website that allows parents to research the various enrichment programs offered by the enrichment provider and register for selected programs. As a result, parents have to separately research each enrichment provider's website in order to identify appropriate programs based on age, subject area, interest, and location. Parents also have to manually resolve scheduling conflicts between different program schedules for two or more children. For example, a parent planning summer camp schedules for two or more children has to sift through many different summer camps offered by multiple enrichment providers to create each child's program schedule while avoiding scheduling conflicts, minimizing travel time, complying with age requirements, and keeping in mind each child's interest. When a program schedule has been determined, parents have to separately register each child with each enrichment provider by creating separate accounts and passwords and filling out each enrichment provider's registration form.

### DESCRIPTION OF THE DRAWINGS

FIG. 1 shows an Internet 102 connected computer system 104 with a data-storage device 106.

FIG. 2 shows a general architectural diagram for various types of a computer systems.

FIGS. 3A-3B show examples of activity camp and class programs, respectively, offered by two enrichment providers.

FIGS. 4A-4B show an example graphical user interface that enables a user to input user criteria and initiate a search for camps or classes offered by enrichment providers.

FIG. 5 shows an example map with a point that represents a location entered by a user.

FIG. 6A shows a graphical user interface of example camp search results and two student schedules of two students.

FIG. 6B shows a graphical user interface of camps projected into schedule slots of two student schedules.

FIG. 6C shows a graphical user interface with a time interval and schedule slot highlighted.

FIG. 7A shows a graphical user interface of example class search results and two student schedules of two students.

FIG. 7B shows a graphical user interface of classes projected into schedule slots of two student schedules.

FIG. 7C shows a graphical user interface with a day of the week and schedule slot highlighted.

FIG. 8 shows a graphical user interface with fields that may be used to refine a search.

FIG. 9 shows a control-flow diagram of a method to schedule activities offered by multiple enrichment providers.

FIG. 10 shows a control-flow diagram of a routine “determine activities that satisfy user criteria” called in FIG. 9.

FIG. 11 shows a control-flow diagram of a routine “provide a graphical user interface of activities that satisfy user criteria” called in FIG. 9.

FIG. 12 shows a control-flow diagram of a routine “refine search for activities” called in FIG. 11.

FIG. 13 shows a control-flow diagram of a routine “project selected activities into student schedules in a graphical user interface” called in FIG. 9.

FIG. 14 shows a control-flow diagram of a routine “complete registration of activities with enrichment providers” called in FIG. 9.

### DETAILED DESCRIPTION

This disclosure is directed to systems and methods that enable users to schedule activities offered by multiple different enrichment providers. The systems and methods allow enrichment providers a place to market and offer activities to users, sifts through numerous activities offered by the enrichment providers to determine the activities that satisfy user criteria, such as date ranges, age, interest, and location, and enables users to simultaneously view the identified activities and create schedules of activities for one or more students, register, and pay for selected activities offered by the enrichment providers. Users may also electronically share activities with other users.

In the following description, various embodiments will be illustrated by way of example and not by way of limitation in the figures. References to various embodiments in this disclosure are not necessarily to the same embodiment. While specific implementations and other details are discussed, it is to be understood that this is done for illustrative purposes only.

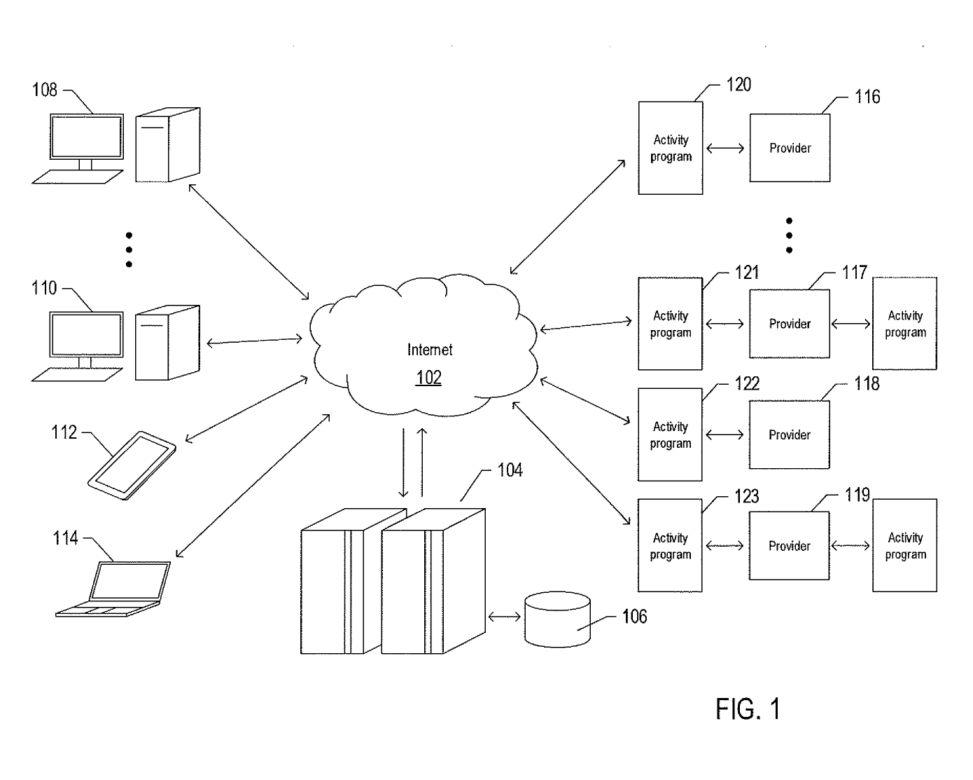

FIG. 1 shows an Internet 102 connected computer system 104 with a data-storage device 106. The computer system 104 stores and executes a computer application that enables numerous users operating personal computers (“PCs”), mobile devices, and lap tops to schedule activities offered by numerous different providers of enrichment programs. As shown in FIG. 1, users interact with graphical user interfaces (“GUIs”) of the computer application by way of the Internet 102 using PCs 108 and 110, a mobile device 112, and a lap top 114. The GUIs of the computer application run in web browsers of the PCs 108 and 110, mobile device 112, and lap top 114. The computer system 104 stores, processes, and delivers web pages created by the computer application in response to user interactions with the GUIs. Alternatively, mobile applications stored and executed on mobile devices, such as the mobile device 112, create GUIs that enable users to interact with the computer application that runs in the computer system 104 to schedule activities offered by numerous different enrichment providers.

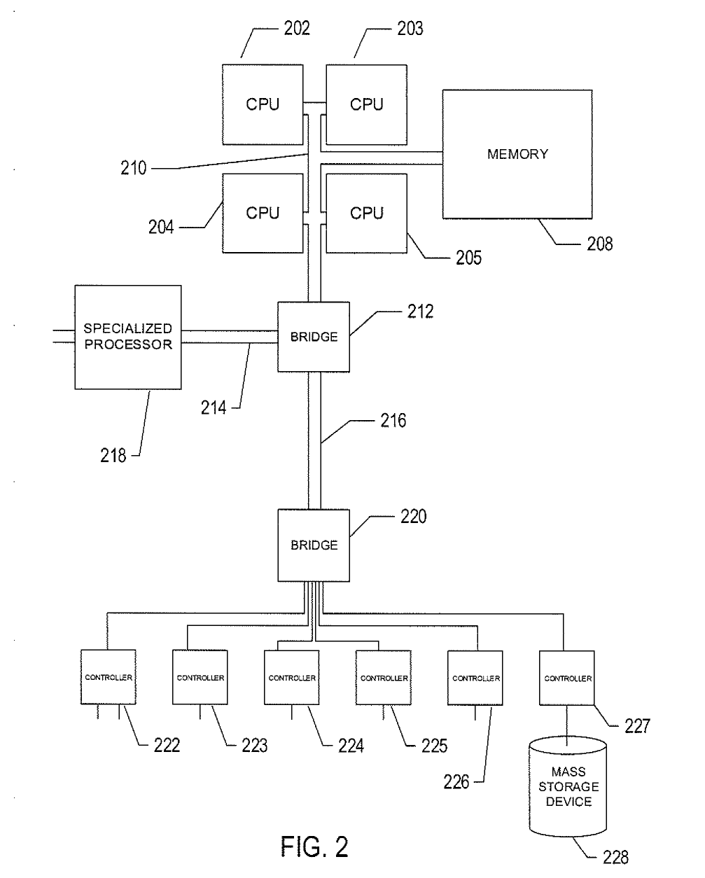

FIG. 2 shows a general architectural diagram for various types of a computer systems. Computer system 104 that runs the computer application may be described with reference to the general architectural diagram shown in FIG. 2, for example. The computer system contains one or multiple central processing units (“CPUs”) 202-205, one or more electronic memories 208 interconnected with the CPUs by a CPU/memory-subsystem bus 210 or multiple busses, a first bridge 212 that interconnects the CPU/memory-subsystem bus 210 with additional busses 214 and 216, or other types of high-speed interconnection media, including multiple, high-speed serial interconnects. These busses or serial interconnections, in turn, connect the CPUs and memory with specialized processors, such as a graphics processor 218, and with one or more additional bridges 220, which are interconnected with high-speed serial links or with multiple controllers 222-227, such as controller 227, that provide access to different types of mass-storage devices 228, electronic displays, input devices, and other such components, subcomponents, and computational devices. It should be noted that computer-readable data-storage devices include optical and electromagnetic disks, electronic memories, and other physical data-storage devices. The computer application may be stored as machine-readable instructions in the computer-readable media (i.e., the data-storage devices) and executed using one or more of the CPUs 202-205

Returning to FIG. 1, enrichment providers 116-119 may upload activity programs 120-123 to the computer system 104 using the Internet 102. Each activity program provides descriptions of the activities, dates, times, prices, and seat limits for each activity offered by the enrichment provider. The descriptions, dates, times, prices, and seat limits of the activity programs uploaded are organized into addressable, formatted data stored in the data-storage device 106 and is searched based on user criteria described below. Certain enrichment providers that upload activity schedules to the computer system 104, such as enrichment providers 117 and 119, may also maintain a separate activity program hosted by the enrichment provider that enables users to register for and enroll in activities directly with the enrichment providers via the enrichment provider's own web site or other means.

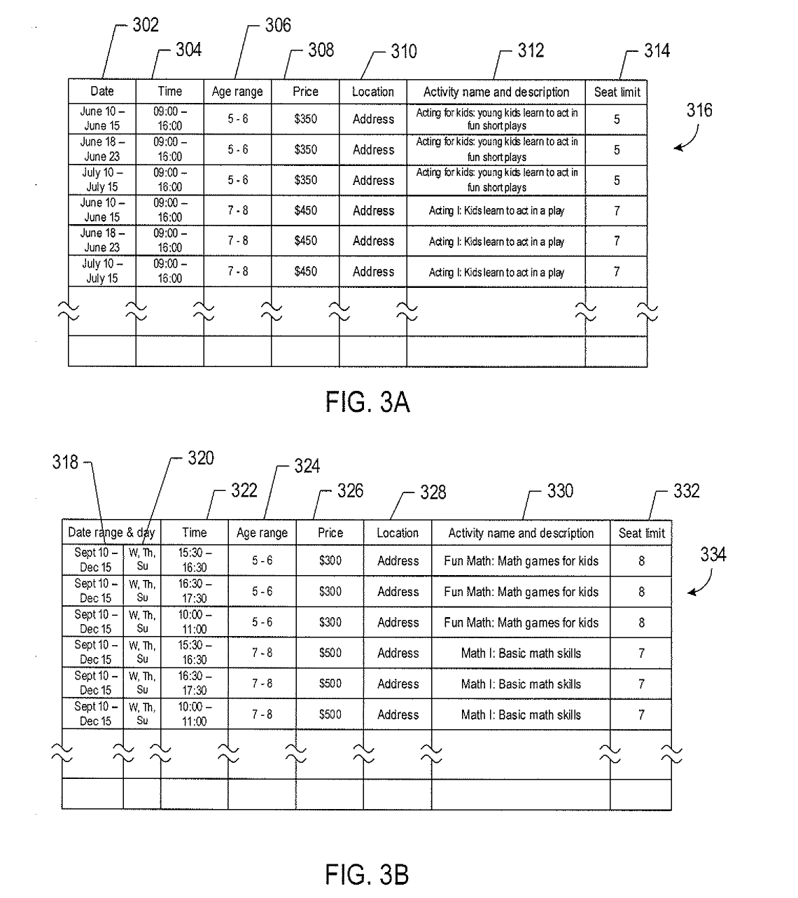

FIG. 3A shows an example of an activity program uploaded to the computer system 104 that list acting camps offered by an enrichment provider. The activity program is displayed in a table comprising columns that list date ranges 302 and times 304, age ranges 306, price, 308, activity location (e.g., address) 310, name and description of camps 312, and seat limit 314. For example, a first camp 316 listed in the activity program runs from June 10-15, from 09:00 to 16:00 each day, has an age range for students of 5-6 years old, a price of $350, and a seat limit of 5 students.

FIG. 3B shows an example of an activity program that list after school math classes offered by an enrichment provider. The activity program is displayed in a table comprising columns that list date ranges 318 and days of the week 320 when the classes are offered. The table also comprises columns that list times 322, age ranges 324, price 326, activity location (e.g., address) 328, name and description of classes 330, and seat limit 332. For example, a first math class 334 listed in the activity program runs from September 10 to December 15 on Monday, Thursday, and Sunday of each week from 15:30 to 16:30, has an age range of 5-6 years old, a price of $300, and a seat limit of 8 students.

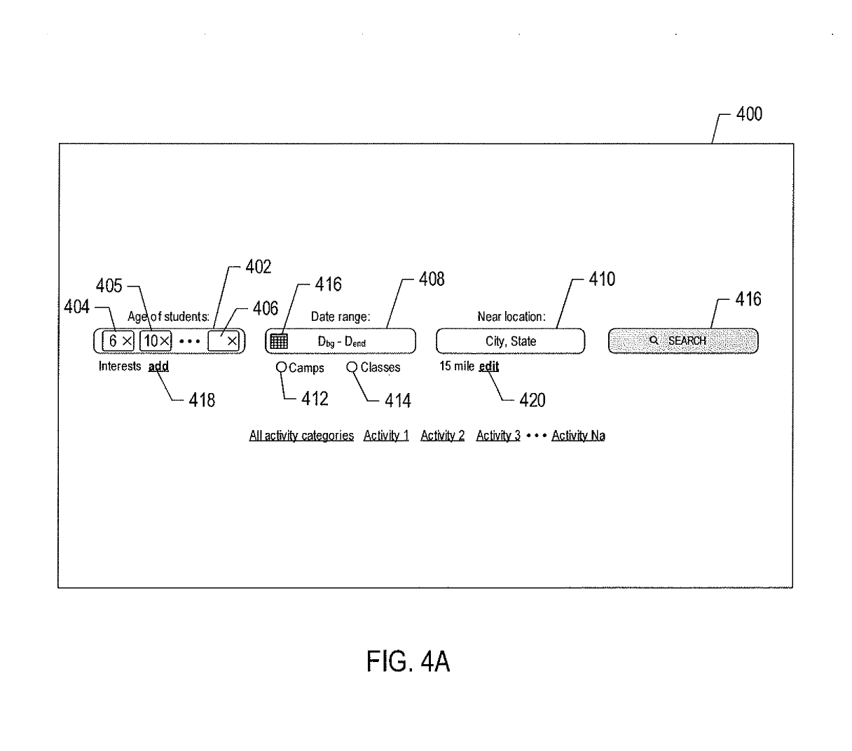

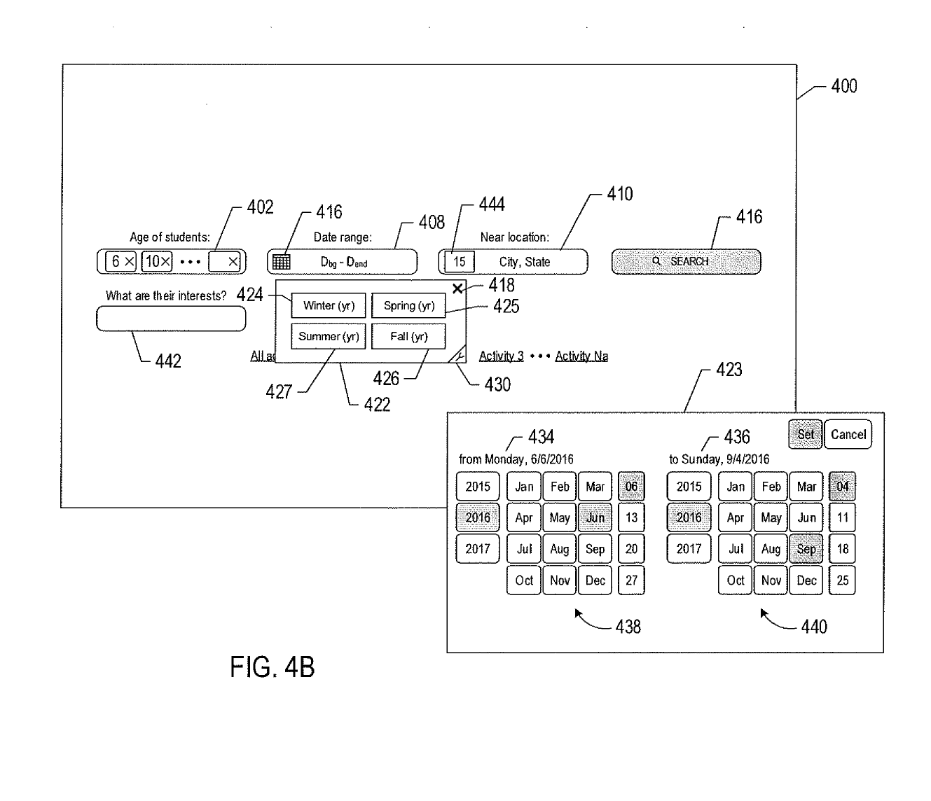

FIG. 4A shows an example GUI 400 that enables a user to input user criteria and initiate a search for camps or classes offered by enrichment providers. The GUI 400 may be displayed in web page and includes a text field 402 with subfields, such as subfields 404-406, located within the text field 402 to input the age of each student. For example, two students of ages 6 and 10 are entered into corresponding text subfields 404 and 405. The GUI 400 includes a text field 408 that is used to enter a date range where “D_{bg}” represents a begin date of the date range and “D_{end}” represents an end date of the date range. The GUI 400 includes a text field 410 to enter a location, such as a city or a specific address, and displays a default travel-distance limit of 15 miles from the location entered into the text field 410. Buttons 412 and 414 enable a user to focus a search on a particular type of activity, which may be camps or classes. A user begins a search for activities that satisfy the parameters entered into the fields 402, 408, and 410 by selecting a search button 416.

The GUI 400 includes a calendar icon 416 and objects 418 and 420 that enable a user to input additional user criteria, as shown in FIG. 4B. In FIG. 4A, selecting the add text button 418 generates a text field 442 in FIG. 4B for entering a list of interest associate with the students. In FIG. 4A, selecting the edit text button 420 generates a text field 444 within the text field 410 in FIG. 4B for entering a distance limit. In FIG. 4A, selecting the calendar icon 416 located within the date range text field 408 creates a message window 422 in FIG. 4B. In FIG. 4B, the message window 422 includes four buttons 424-427 that correspond to the four seasons of the seasonal calendar and are labeled “winter,” “spring,” “fall,” and “summer.” Selecting one the four buttons 424-427 inserts the date range for classes and camps in a period of time that overlaps with one of the four seasons of the seasonal calendar. For example, clicking the spring button 425 inputs the begin date and the end data in the text field 408 of a spring period for classes and camps offered by enrichment providers. The spring period over laps with the actual spring season of the seasonal calendar. Selecting the “X” 428 closes the message window 422. Selecting the tool icon 430 in the message window 422 generates a begin-and-end date window 432. The begin-and-end date window 432 displays a begin date 434 and an end date 436 and button pads 438 and 440. The button pads 438 and 440 are associated with the begin date 434 and end date 436, respectively, and may be used to adjust begin and end dates for searching for classes or camps. Each button pad includes year buttons, twelve month buttons, a column of date buttons that display the date of each Monday in the selected month and year. A user may change begin and end data by Selecting a year and month of one of the button pads. The dates of each Monday in the selected year and month are displayed on the date buttons. The user then selects the Monday date.

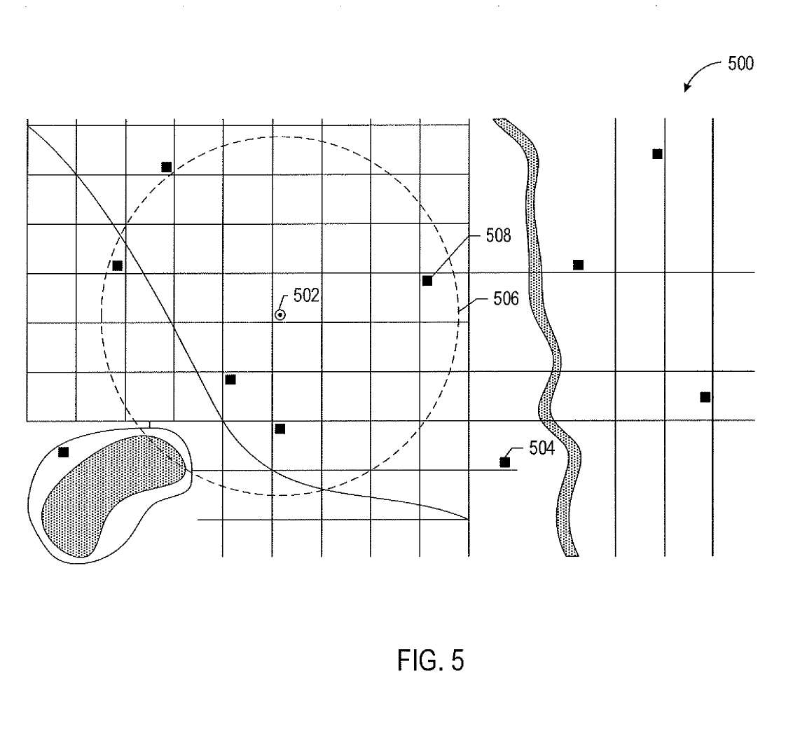

When a search is started by selecting the search button 416 in FIG. 4, the structured database of activities is searched to identify any activities with age limits, dates, and locations that satisfy the user criteria and have available seats. For example, activities that are located within the travel-distance limit are determined based on the location entered in the text field 410 and the addresses of each activity. FIG. 5 shows an example map 500 with a point 502 that represents a location entered by a user. Shaded squares, such as shaded square 504, represent the locations of activities offered by enrichment providers. Dashed circle 506 has a radius equal to the travel-distance limit and is centered at the user entered location 502. Activities, such as activity 508, located within the circle 506 are identified as candidate activities. On the other hand, activities located outside the circle 506 (i.e., travel distance that exceed the travel-distance limit), such as the activity 504, are excluded from further consideration.

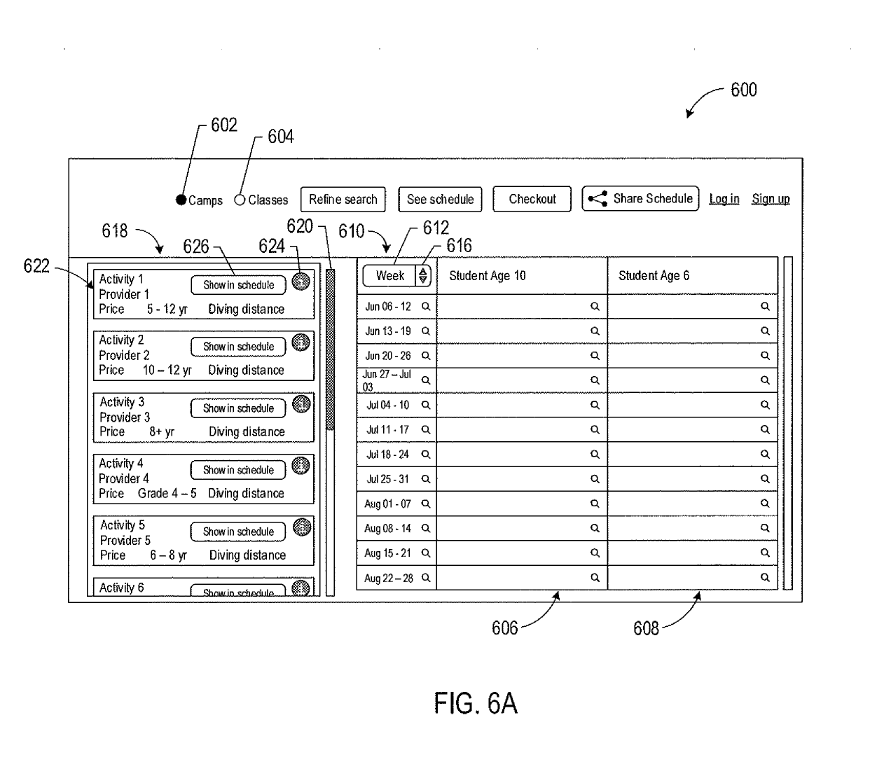

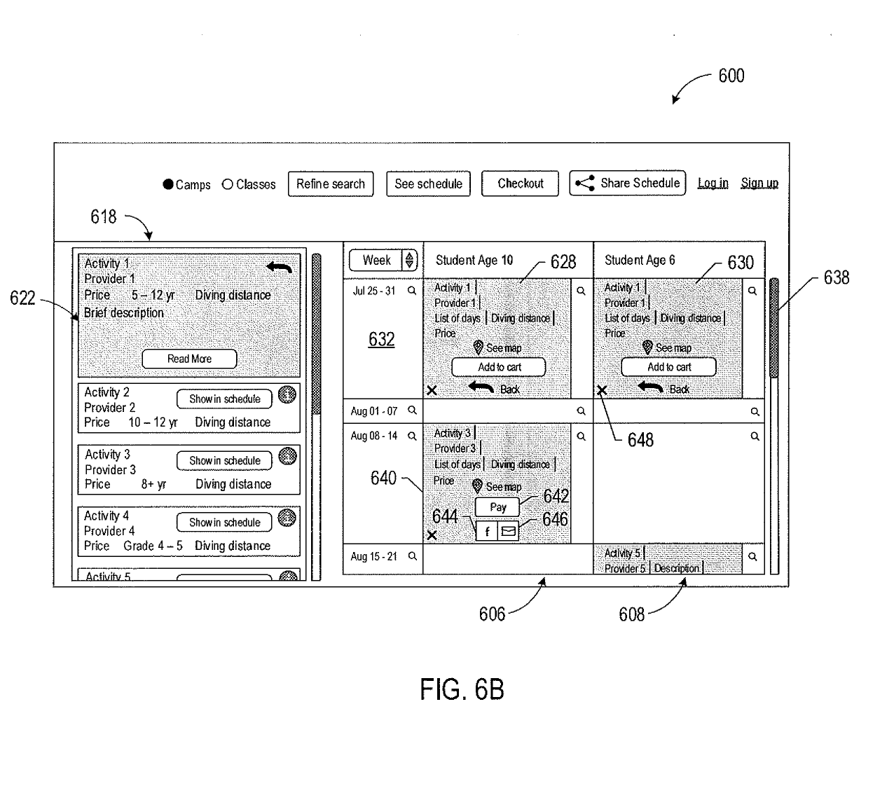

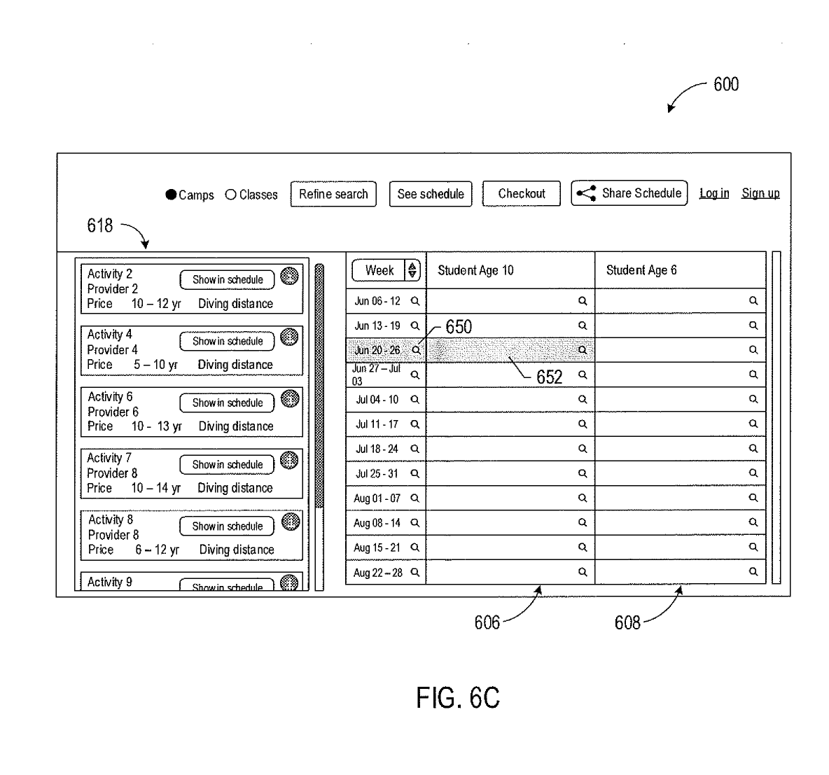

FIG. 6A shows a GUI 600 of example camp search results and two open student schedules of two students. In this example, the user selected camps as indicated by shaded circle 602. The user may switch to classes that satisfy the same user criteria by selecting open circle 604. A student camp schedule 606 is displayed for student age 10 and a student camp schedule 608 is displayed for a student age 6. Column 610 list consecutive time intervals that correspond to consecutive weeks within the date range for the time interval “weeks” in time interval field 612. Examples of consecutive weeks for the date range entered in date field 408 of FIG. 4A are listed and displayed in the consecutive time intervals of column 610. A user may use the arrows 616 to change the time interval to months, weeks, days, hours, or minutes and the units of corresponding consecutive time intervals of column 610 are changed to the time units of the time interval selected using the arrows 616. Each student schedule has a column of schedule slots that correspond to the time intervals. The GUI 600 includes an activities box 618 that displays a list of camps that satisfy the user criteria. The user may scroll up and down the list of camps in the activities box 618 using a scroll bar 620. Each camp is listed in a separate field with the title of the camp, name of enrichment provider, price, age range (or grade level), driving distance from user entered location, an information icon that when selected produces a separate window that presents more detailed information about the activity and the enrichment provider, and a button labeled “show in schedule.” When the button “show in schedule” is selected, the camp is projected into one or more of the schedule slots of the student schedules 606 and 608 that correspond to one or more time intervals when the camp is offered and satisfy the ages of the students. For example, camp 622 displays abbreviated information about an example camp titled “Activity 1” provided by an example enrichment provider “Provider 1” for children between 5 and 12 years old. Selecting the information icon 624 produces a separate window (not shown) that presents more detailed information about the camp “Activity 1” and the provider “Provider 1.” Selecting the “show in schedule” button 626 projects the camp into one or more schedule slots of both student schedules 606 and 608 that correspond to one or more time intervals when the activity is offered as shown in FIG. 6B.

FIG. 6B shows camps projected into schedule slots of the student schedules 606 and 608. After selecting the “show in schedule” button 626 of FIG. 6A, the camp 622 is projected into schedule slots 628 and 630 for the time interval 632 of corresponding student schedules 606 and 608 because the camp is available for both students. The camp 622 in activity box 618 is highlighted and expanded to provide more details. A camp that has been projected into a schedule slot is a candidate camp for adding the schedule by the user and the schedule slot is used to display the camp name, provider name, list of days, driving distance from the user location to the camp location, price, a “See map” button that enables a user to view the location of the activity in a map presented in a separate window, such as the map shown in FIG. 5, and an “add to cart” button, such as “add to cart” buttons 634 and 636. By displaying the activities in the student schedules, a user may view and scroll up and down the student schedules using a scroll bar 638 to visually identify the time interval of each camp. Selecting the “add to cart” button adds a candidate camp to the student schedule and adds the camp to a cart for check out. For example, schedule slot 640 shows a camp “Activity 3” that has been added to the student schedule 606. The schedule slot 640 includes a “pay” button 642 that enables a user to pay separately for the camp “Activity 3” by displaying a checkout window for the camp alone. The field also includes buttons 644 and 646 that enable a user to share the camp selection with others using social media and email, respectively. The camps projected and/or added to a student schedule include delete icons, such as delete icon “X” 648, that enables a user to delete a projected activity from a student schedule or delete an added activity from a student schedule and the cart.

Each time interval of the date range and schedule slot of the student schedules in the GUI 600 may be selected in order to display camps offered for a particular time interval and/or schedule slot. When a time interval is selected, the list of camps in the activities box 618 reduces to only the camps that are offered in the time interval. When a schedule slot of a student schedule is selected, the list of camps in the activities box 618 is reduced to only the camps that are within the corresponding time interval and have age ranges that accommodate the age of the corresponding student. FIG. 6C shows a GUI 600 with a time interval 650 and schedule slot 652 highlighted. By selecting the schedule slot 652, the list of camps in the activities box 618 is reduced to only the camps that are offered during the week of “June 20-26” and accommodate a student of 10 years old. The user may then select any of the camps listed in activities box 618 for projection into the schedule slot 652 by selecting the “show in schedule” button as described above with reference to FIG. 6A.

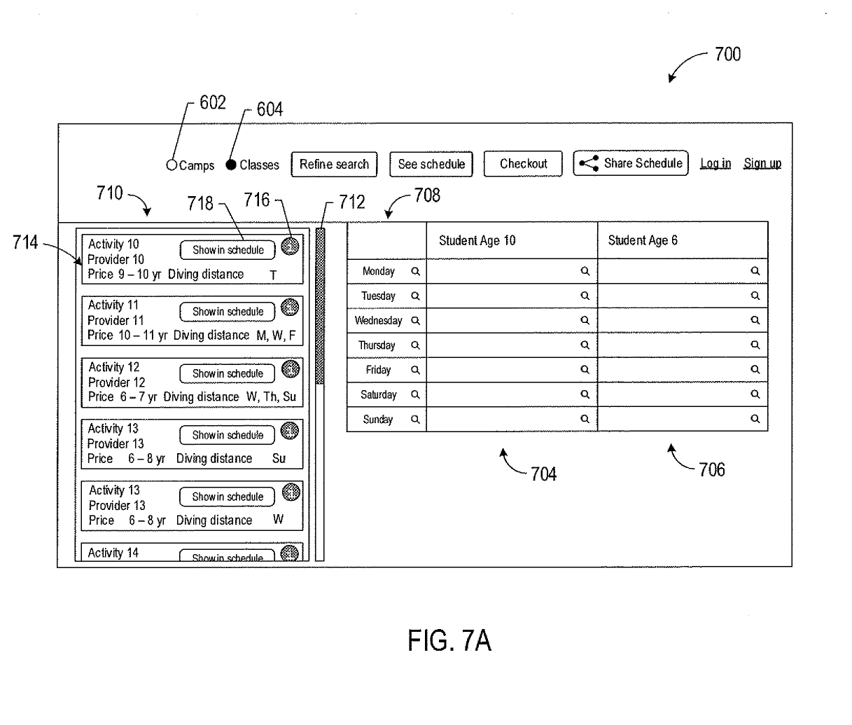

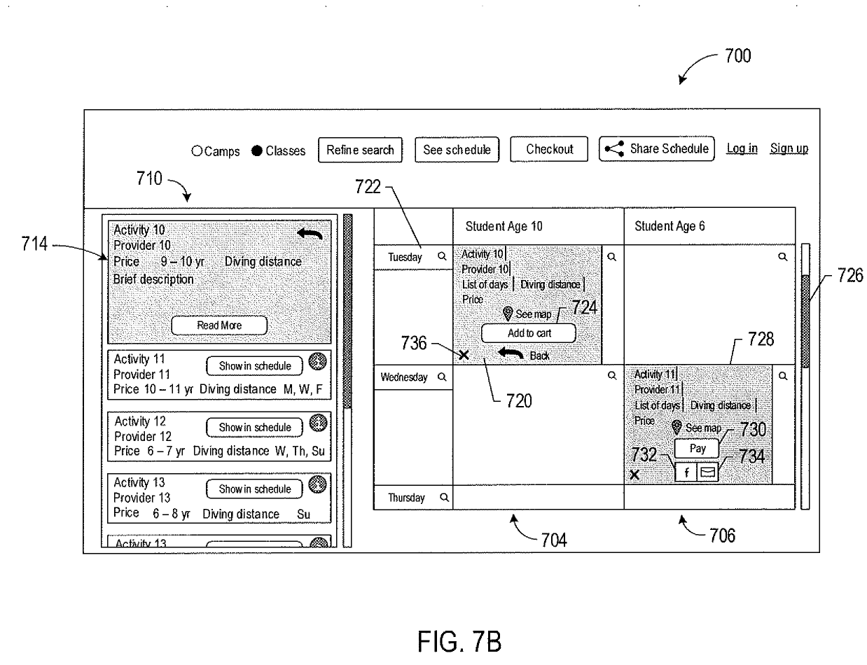

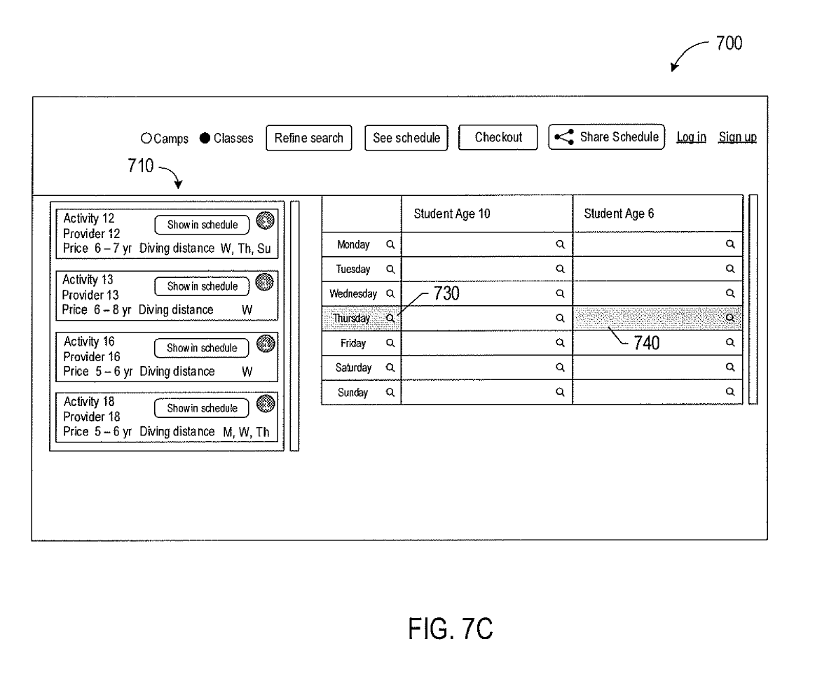

FIG. 7A shows a GUI 700 of example class search results and two student schedules of two students. In this example, the user selected classes as indicated by shaded circle 702. An open student class schedule 704 is displayed for student age 10 and an open student class schedule 706 is displayed for a student age 6. When classes are selected by the user, the time intervals may be seven days of a week. In other implementations, the time interval may be months, weeks, days, or hours depending on the types of classes. Column 708 list consecutive days that correspond to consecutive days of week beginning with Monday and ending with Sunday. Each student class schedule has a column of blank schedule slots that correspond to the days of the week. The GUI 700 includes a box 710 that displays a list of classes that satisfy the user criteria. The user may scroll up and down the list of classes in the box 710 using a scroll bar 712. Each class is listed in a separate field with the title of the class, name of enrichment provider, price, age range (or grade level), driving distance from user entered location, an information icon that when selected produces a separate window that presents more detailed information about the class and the enrichment provider, and a button labeled “show in schedule.” When the button “show in schedule” button is selected, the class is inserted into one or more of the blank schedule slots of the student class schedules 704 and 704 that correspond to one or more days when the class is offered and satisfy the ages of the students. For example, field 714 displays abbreviated information about an example class titled “Activity 10” provided by an example enrichment provider “Provider 10” for children between 9 and 10 years old. Selecting the information icon 716 produces a separate window (not shown) that presents more detailed information about the “Activity 10” and the provider “Provider 10.” Selecting the “show in schedule” button 718 projects the class into one or more blank schedule slots of both student schedules 704 and 706 that correspond to days when the class is offered as shown in FIG. 7B.

FIG. 7B shows classes projected into schedule slots of the student schedules 704 and 706. After selecting the “show in schedule” button 718 of FIG. 7A, the class 714 is projected into schedule 720 of for the Tuesday 722 of student schedule 704. The class 714 in box 710 is highlighted and expanded to provide more details. A class projected into a student schedule is a candidate class and the schedule slot displays additional information, such as the class name, provider name, list of days of week the class is offered, driving distance, price, a “See map” button that enables a user to view the location of the activity in a map presented in a separate window, such as the map shown in FIG. 5, and an “add to cart” button, such as button 724. Selecting the “add to cart” button may also produce a window that explains the class requires a monthly subscription and payments will be taken each payment period from the credit card or account used to pay for the class. The user then has the option to continue with the purchase or not. By displaying the classes in the student schedules, a user may view and scroll up and down the student schedules using a scroll bar 726 to visually identify the time interval of each activity. Selecting the “add to cart” button adds the activity to the student schedule and adds the activity to a cart for check out. For example, schedule slot 728 shows a class “Activity 11” that has been added to the student schedule 706. The schedule slot 728 includes a “pay” button 730 that enables a user to pay separately for the class “Activity 11” by displaying a checkout window for the activity alone. The schedule slot also includes buttons 732 and 734 that enable a user to share the activity with others using social media and email, respectively. The activities projected and/or added to a student schedule include delete icons, such as delete icon “X” 736, that enable a user to delete a projected class from a student schedule or delete an added class from a student schedule and from the cart.

A day of the week and a schedule slot of the student schedules in the GUI 700 may be selected. When a day of the week is selected, the list of classes in the box 710 is reduced to only those classes that are offered on the selected day. When a schedule slot of a student schedule is selected, the list of classes in the box 710 reduces to only those classes that are offered in the corresponding day of the week and have age ranges that accommodate the age of the corresponding student. FIG. 7C shows the GUI 700 with a Thursday 738 and schedule slot 740 highlighted. By selecting the schedule slot 740, the list of classes in the box 710 is reduced to only the classes that are offer a class on “Thursday” and accommodate a student of 6 years old. The user may then project any of the classes listed in the box 710 into the schedule slots that correspond to the days of the week the class is offered as described above with reference to FIG. 7A.

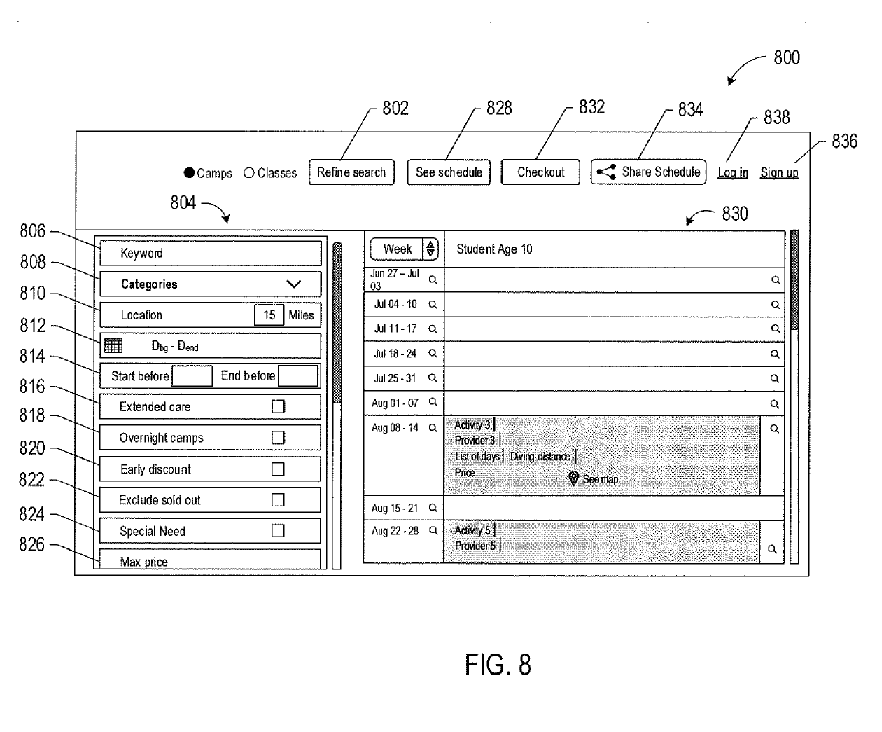

The camp GUI 600 and class GUI 700 shown in FIGS. 6 and 7, respectively, have a series of buttons identified as “Refine search,” “See schedule,” “Checkout,” “Share schedule,” “Log in,” and “Sign in” located above the student schedules and activities boxes. FIG. 8 shows a camp GUI 800 with fields that may be used to refine a search and displays a student schedule of activities 830. The student schedule of activities list the activities that have been added to the student schedule by the user as described above and are not candidate activities. As shown in FIG. 8, when the “Refine search” button 802 is selected, the camps listed in the activities box 618 of the GUI 600 is replaced by a list of refine search parameters in a refine-search-parameters box 804. The refine search parameters include a keyword field 806 to enter more keywords that may be associated with camps and a categories button 808 that expands to list specific camp categories, such as but not limited to, arts and crafts, board games, cooking, dance, fitness, foreign languages, gymnastics, math, music, programming, science, and sports. Each of the categories includes a check box that when checked, further limits the search to only the camps that belong to one or more checked categories. A location field 810 enables a user to change the location and includes a sub-field to change the travel-distance limit as described above with reference to FIG. 4B. A date range field 812 with a calendar icon enables a user to change the date range in the same manner described above with reference to FIG. 4B. Start before and end before times may be entered into a sub-text fields of a time field 814. Any one or more of the extended care 816, overnight camps 818, early discount 820, exclude sold out 822, and special need 824 fields may be checked to further narrow the search for activities. Max price field 826 enables a user to enter a maximum price the user is willing to pay for camps. The refine-search-parameters box 804 may include fields to select “full day,” “morning,” and “afternoon” camps. The “See schedule” button 828 enables a user to view a schedule of selected camps, such as the example student schedule of activities 830 of selected camps for the student age 10. The “Checkout” button 832 enables a user to proceed to a checkout and pay enrichment providers for the camps selected. When a camp is selected and payment is complete the number of available seats for the camp is decremented and registration with the enrichment providers is completed. The “Share Schedule” button 834 enables a user to share a student schedule with others using social media or email. The “Sign in” text link 836 enables the user to create an account and fill in information that satisfies the registration requirements of the enrichment providers so that when the user checks out and pays for the selected activities in the student schedules of activities, each of the enrichment providers receives complete registration information about the user and the students enrolled in the activities. The “Log in” text link 838 enables the user to log into an existing user account.

In other implementations, a group of users may be created to schedule activities for a number of students. A group is formed by a user. Each user in the group is able to join one or more students to the group. When an activity is scheduled, the activity is inserted into student schedules for all the other users in the group in real time. When an activity is paid for and confirmed by a user in the group, the other users in the group are notified, such as via email.

In other implementations, a user can enter different addresses, such as work and home addresses in order to form a daily driving pattern. The methods and systems sorts the search result based on the driving distance and may suggest a best route for the user.

In other implementations, a user may narrow search results using interactive activity filtering. A user may remove an enrichment provider from a list of enrichment providers used to search for activities. As a result, activities offered by the enrichment provider selected for removal no longer appear in the list of activities displayed in the activities box. The user may also remove certain types of activities based on keywords, such as “soccer” or “cooking.” As a result, activities that include the keywords are excluded from the list of activities displayed in the activities box. A user can reset the filtering parameters at any time.

In other implementations, a user may create a preferred list of activities. A user may select from the list of activities one or more activities the user prefers. These activities are added to a preferred list of activities. The user may select schedule all activities in the preferred list of activities. The methods and systems automatically generate one or more student schedules based on the preferred activities.

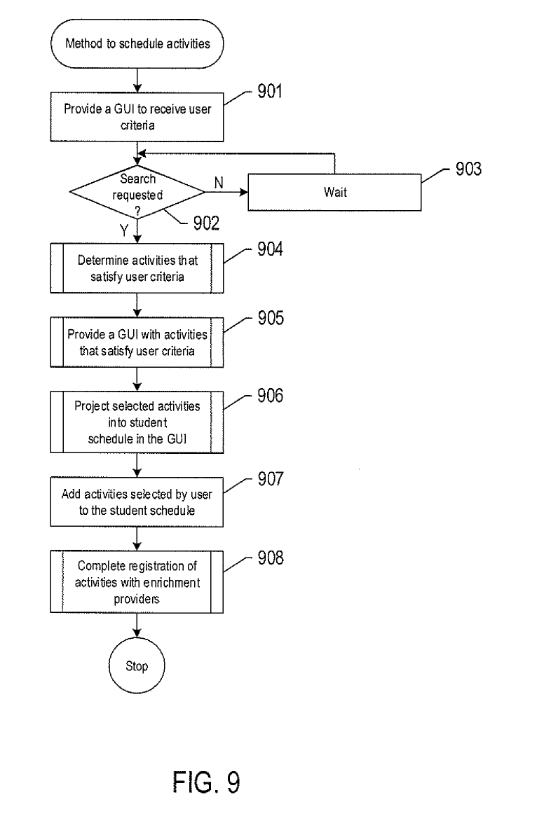

FIG. 9 shows a control-flow diagram of a method to schedule activities offered by multiple enrichment providers. In block 901, a graphical user interface is provided in a web browser as described above with reference to FIGS. 4A-4B to receiver user criteria as input. In decision block 902, when a search is requested, control flows to block 904, otherwise, control flows to block 903. In block 904, a routine “determine activities that satisfy user criteria” is called to determine activities offered by the multiples enrichment providers that satisfy the user criteria received in block 901. In block 905, a routine “provide a graphical user interface with activities that satisfy user criteria” is called to provide a graphical user interface in the web browser that displays a list of activities that match the user criteria and display one or more student schedules. In block 906, a routine “project selected activities into student schedules in a graphical user interface” is called to project activities into schedule slots of the one or more student schedules to generate one or more student schedules of candidate activities. In block 907, candidate activities of the one or more student schedules of candidate activities that are selected by the user are used to generate one or more student schedules of activities, as described above with reference to FIGS. 6B, 7B, and 8. In block 908, a routine “complete registration of activities with enrichment providers” is called.

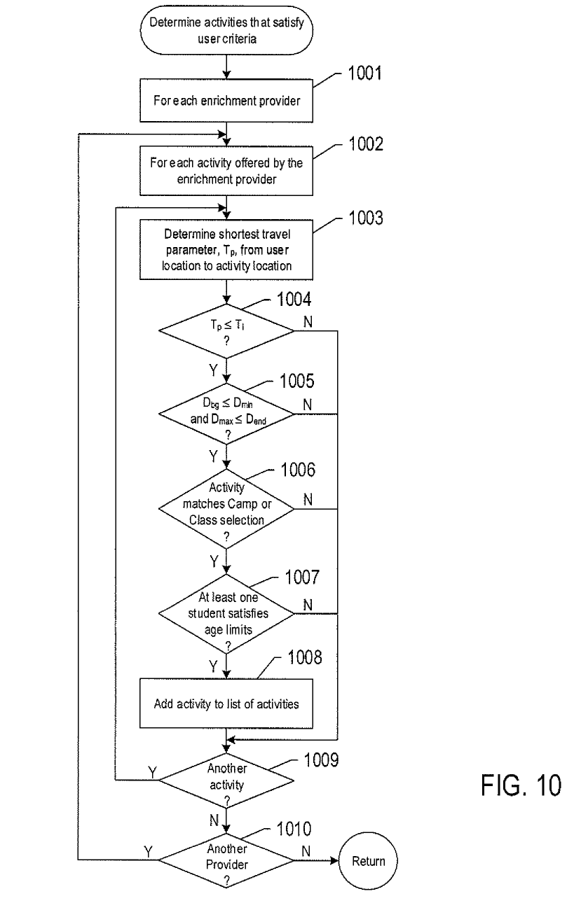

FIG. 10 shows a control-flow diagram of the routine “determine activities that satisfy user criteria” called in block 904 of FIG. 9. A loop beginning with block 1001 repeats the operations of blocks 1002-1010 for each enrichment provider. A loop beginning with block 1002 repeats the operations of blocks 1003-1009 for each activity offered by an enrichment provider. In block 1003, a travel-distance parameter Tₚ is calculated from the user location entered in block 901 and a travel-distance limit Tₗ. In one embodiment, the travel-distance parameter and the travel-distance limit may be driving distances, as described above with reference to FIG. 5. In another embodiment, the travel-distance parameter and the travel-distance limit may be the driving time. In decision block 1004, when the travel-distance parameter is less than the travel-distance limit, control flow to decision block 1005. In decision block 1005, when a date range entered by the user in block 901 is within the begin date and end date of the activity, control flow to block 1006. In block 1006, when the activity matches the type of activity entered by the user in the block 901, control flows to block 1007. For example, the type of activity may be camps or classes. In block 1007, when the age of at least one of the students matches the age limits (or grade limits) of the activity, control flows to block 1008. In block 1008, the activity is added to a list of activities. In block 1009, another activity selected. In block 1010, another enrichment provider is selected.

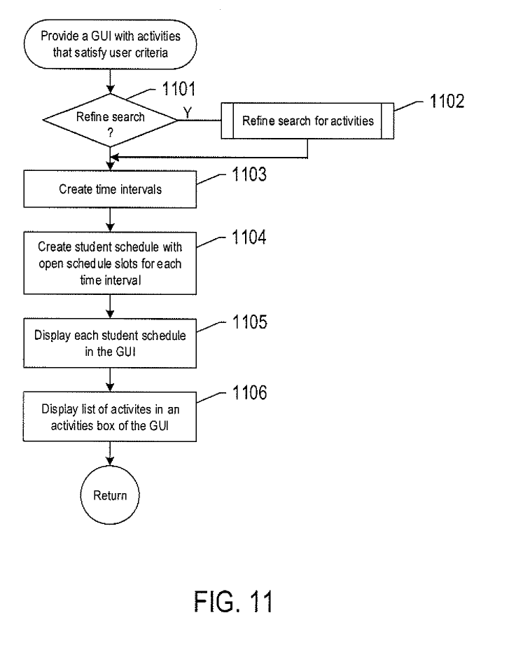

FIG. 11 shows a control-flow diagram of the routine “provide a graphical user interface of activities that satisfy user criteria” called in block 905 of FIG. 9. In block 1101, a refine search is selected by a user, as described above with reference to FIG. 8, control flows to block 1102, otherwise, control flows to block 1102. In block 1102, a routine “refine search for activities” is called. In block 1103, time intervals are created depending on the type of activity. In block 1104, for each student, one or more student schedules are created with open schedule slots for each time interval. In block 1105, the time intervals and one or more student schedules are created in a graphical user interface as described above with reference to FIGS. 6A and 7A. In block 1106, the list of activities produced in the routine of FIG. 10 are displayed in an activities box of the graphical user interface as described above with reference to FIGS. 6A and 7A.

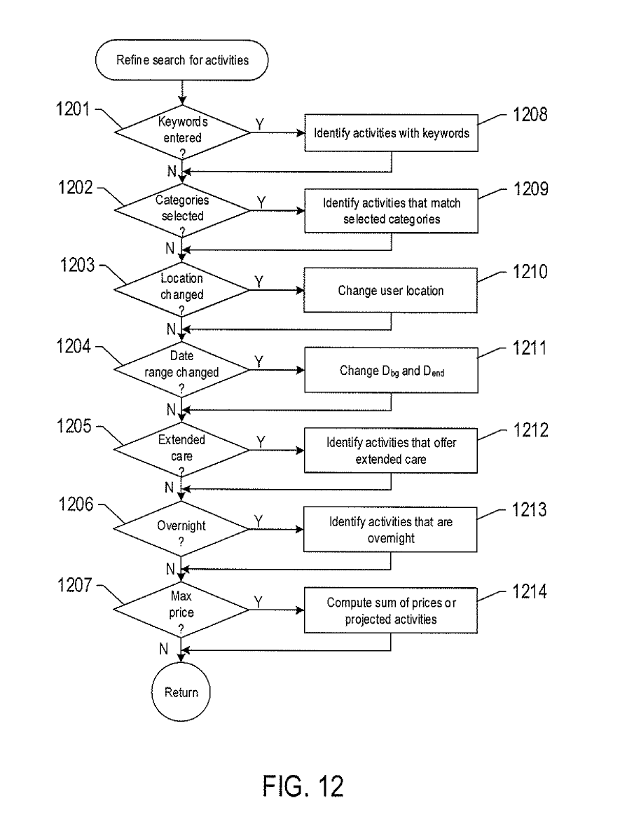

FIG. 12 shows a control-flow diagram of the routine “refine search for activities” called in block 1102 of FIG. 11. Decision blocks 1201 correspond to refine-search parameters that may be selected by a user to further refine or narrow a search for activities as described above with reference to FIG. 8. Blocks 1208-1209 represent operations carried out in response to a user selecting one of the refine-search parameters. For example, when a user selects “extended care” as represented by decision block 1205, control flows to block 1212, in which list of activities is update to only the activities that offer extended care.

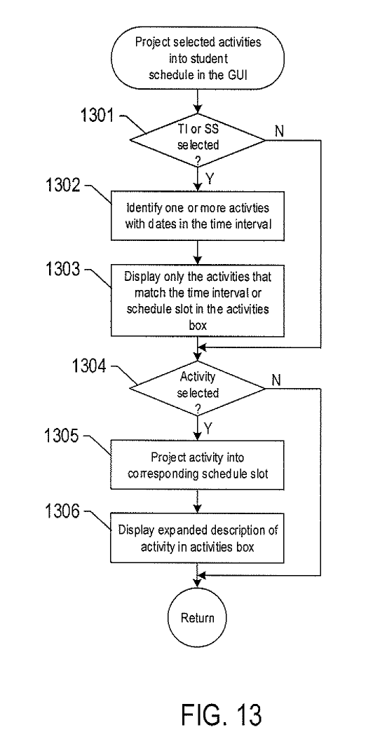

FIG. 13 shows a control-flow diagram of the routine “project selected activities into student schedules in a graphical user interface” called in block 906 of FIG. 9. In decision block 1301, when a time interval or a schedule slot is selected as described above with reference to FIGS. 6C and 7C, control flows to block 1302. In block 1302, one or more activities with dates in the time interval or dates in the time interval that corresponds to the schedules slot are identified. In block 1303, only the activities identified in block 1302 are displayed in the activities box as described above with reference to FIGS. 6A and 7A. In decision block 1304, when an activity is selected from the list of activities in the activities box as described above with reference to FIG. 6A control flows to block 1305. In block 1305, the activity is projected into each of one or more schedule slots with time intervals that match the dates the activity is offered as described above with reference to FIGS. 6B and 7B to produce one or more student schedules of candidate activities. In block 1306, an expanded description of each of the candidate activities is provided in the activities box as described above with reference to FIGS. 6B and 7B.

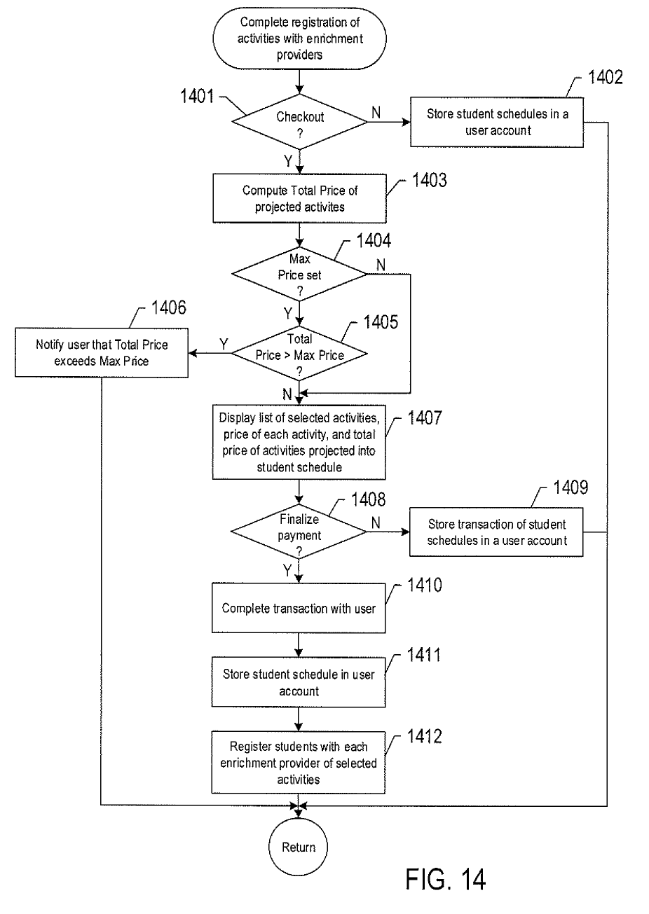

FIG. 14 shows a control-flow diagram of the routine “complete registration of activities with enrichment providers” called in block 908 of FIG. 9. In decision block 1401, when a checkout is selected, control flows to block 1403, otherwise control flows to block 1402 and the one or more student schedules may be stored under the user account. In block 1403, a total price of the activities in the one or more student schedules of activities are computed. In decision block 1404, when a maximum price is set by the user, control flows to decision block 1405. In decision block 1405, when the total price is greater than the maximum price set by the user control flows to block 1406 where the user is notified the total price of the activities is greater than the maximum price and the user may be provided with graphical user interface that enables to the user to reset the maximum price or delete activities from the one or more student schedules. In block 1407, a list of selected activities, price of each activity, and a total price of activities are displayed in a graphical user interface. In decision block 1408, when the user finalizes payment control flows to block 1410, otherwise, in block 1409, the transaction is stored is stored under the user's account. In block 1410, the transaction to pay for the activities in the student schedules is completed with the user. In block 1411, the one or more student schedules of activities are stored under the user's account in a data-storage device. In block 1412, students are registered with each of the enrichment providers of the activities selected in the one or more student schedules of activities. The number of available seats in the activities in the one or more student schedules of activities are decremented.

It is appreciated that the description of the disclosed embodiments is provided to enable any person skilled in the art to make or use the present disclosure. Various modifications to these embodiments will be clear to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

1. A computer implemented method to schedule activities offered by multiple enrichment providers, the method comprising:
providing a first graphical user interface in a web browser, the first graphical user interface enabling a user to enter user criteria that includes a user location, date range, type of activities, travel-distance limit, and ages of a student;
determining activities offered by the multiple enrichment providers that satisfy the user criteria;
providing a second graphical user interface in the web browser, the second graphical user interface displays a list of activities that match the user criteria in an activities box and displays a student schedule with schedule slots;
projecting activities selected by the user into corresponding schedule slots of the student schedule to generate a student schedule of candidate activities;
adding candidate activities selected by the user to generate a student schedule of activities; and
completing registration of activities in the student schedule of activities with the enrichment providers.

2. The method of claim 1 wherein determining activities offered by the multiple enrichment providers that satisfy the user criteria comprises:
searching for activities in a structure database of activities stored in a data-storage device;
determining shortest travel distance from the user location to a location of each activity offered by the enrichment providers; and
adding an activity to the list of activities when the shortest travel distance is less than the travel-distance limit, dates the activity is offered are within the data range, the activity matches the type of activity, and age the student is within age limits of the activity.

3. The method of claim 1 wherein displaying the second graphical user interface in the web browser comprises:
creating a student schedule for each student, each student schedule having a schedule slot associated with each time interval;
displaying each student schedule in the second graphical user interface; and
displaying the list of activities in the activities box of the second graphical user interface.

4. The method of claim 1 wherein determining activities offered by the multiple enrichment providers comprises displaying a refine-search-parameters box in the second graphical user interface, the refine-search-parameters box enables the user to refine the user criteria by entering one or more keywords, selecting an activity category, changing the user location, changing the date range, selecting activities that offer extended care, selecting activities that offer overnight activities, and entering a maximum price.

5. The method of claim 1 wherein projecting the activities selected by the user into corresponding schedule slots of the student schedule comprises:
projecting an activity into a corresponding schedule slot of the student schedule when the activity is selected by the user from the list of activities; and
displaying an extended description of the activity in the activities box.

6. The method of claim 5 further comprises:
identifying activities in the list of activities with dates in a time interval selected by the user or in a time interval associated with a schedule slot selected by the user; and
displaying the activities that match the time interval selected by the user or time interval of the schedule slot selected by the user in the activities box.

7. The method of claim 1 wherein completing registration of activities in the student schedule of activities with the enrichment providers comprises:
displaying a checkout window in the web browser, the checkout window displaying the activities added to the student schedule;
computing total price of activities added to the student schedule;
displaying a notification that the total price is greater than the maximum price and returning to the second graphical user interface, when the user has provided a maximum price; and
registering the student with each enrichment provider that offers the activities added to the student schedule.

8. A system to schedule activities offered by multiple enrichment providers, the system comprising:
one or more processors;
one or more data-storage devices; and
machine-readable instructions stored in the one or more data-storage devices that when executed using the one or more processors controls the system to carry out
providing a first graphical user interface in a web browser, the first graphical user interface enabling a user to enter user criteria that includes a user location, date range, type of activities, travel-distance limit, and ages of the student;
determining activities offered by the multiple enrichment providers that satisfy the user criteria;
providing a second graphical user interface in the web browser, the second graphical user interface displays a list of activities that match the user criteria in an activities box and displays a student schedule with schedule slots;
projecting activities selected by the user into corresponding schedule slots of the student schedule to generate a student schedule of candidate activities;
adding candidate activities selected by the user to generate a student schedule of activities; and
completing registration of activities in the student schedule of activities with the enrichment providers.

9. The system of claim 8 wherein determining activities offered by the multiple enrichment providers that satisfy the user criteria comprises:
searching for activities in a structure database of activities stored in a data-storage device;
determining shortest travel distance from the user location to a location of each activity offered by the enrichment providers; and
adding an activity to the list of activities when the shortest travel distance is less than the travel-distance limit, dates the activity is offered are within the data range, the activity matches the type of activity, and age the student is within age limits of the activity.

10. The system of claim 8 wherein displaying the second graphical user interface in the web browser comprises:
creating a student schedule for each student, each student schedule having a schedule slot associated with each time interval;
displaying each student schedule in the second graphical user interface; and
displaying the list of activities in the activities box of the second graphical user interface.

11. The system of claim 8 wherein determining activities offered by the multiple enrichment providers comprises displaying a refine-search-parameters box in the second graphical user interface, the refine-search-parameters box enables the user to refine the user criteria by entering one or more keywords, selecting an activity category, changing the user location, changing the date range, selecting activities that offer extended care, selecting activities that offer overnight activities, and entering a maximum price.

12. The system of claim 8 wherein projecting the activities selected by the user into corresponding schedule slots of the student schedule comprises:
projecting an activity into a corresponding schedule slot of the student schedule when the activity is selected by the user from the list of activities; and
displaying an extended description of the activity in the activities box.

13. The system of claim 12 further comprises:
identifying activities in the list of activities with dates in a time interval selected by the user or in a time interval associated with a schedule slot selected by the user; and
displaying the activities that match the time interval selected by the user or time interval of the schedule slot selected by the user in the activities box.

14. The system of claim 8 wherein completing registration of activities in the student schedule of activities with the enrichment providers comprises:
displaying a checkout window in the web browser, the checkout window displaying the activities added the student schedule;
computing total price of activities added to the student schedule;
displaying a notification that the total price is greater than the maximum price and returning to the second graphical user interface, when the user has provided a maximum price; and
registering the student with each enrichment provider that offers the activities added to the student schedule.

15. A non-transitory computer-readable medium encoded with machine-readable instructions that implement a method carried out by one or more processors of a computer system to perform the operations of
providing a first graphical user interface in a web browser, the first graphical user interface enabling a user to enter user criteria that includes a user location, date range, type of activity, travel-distance limit, and age of a student;
determining activities offered by the multiple enrichment providers that satisfy the user criteria;
providing a second graphical user interface in the web browser, the second graphical user interface displays a list of activities that match the user criteria in an activities box and displays a student schedule with schedule slots;
projecting activities selected by the user into corresponding schedule slots of the student schedule to generate a student schedule of candidate activities;
adding candidate activities selected by the user to generate a student schedule of activities; and
completing registration of activities in the student schedule of activities with the enrichment providers.

16. The medium of claim 15 wherein determining activities offered by the multiple enrichment providers that satisfy the user criteria comprises:
searching for activities in a structure database of activities stored in a data-storage device;
determining shortest travel distance from the user location to a location of each activity offered by the enrichment providers; and
adding an activity to the list of activities when the shortest travel distance is less than the travel-distance limit, dates the activity is offered are within the data range, the activity matches the type of activity, and age the student is within age limits of the activity.

17. The medium of claim 15 wherein displaying the second graphical user interface in the web browser comprises:
creating a student schedule for each student, each student schedule having a schedule slot associated with each time interval;
displaying each student schedule in the second graphical user interface; and
displaying the list of activities in the activities box of the second graphical user interface.

19. The medium of claim 15 wherein determining activities offered by the multiple enrichment providers comprises displaying a refine-search-parameters box in the second graphical user interface, the refine-search-parameters box enables the user to refine the user criteria by entering one or more keywords, selecting an activity category, changing the user location, changing the date range, selecting activities that offer extended care, selecting activities that offer overnight activities, and entering a maximum price.

19. The medium of claim 15 wherein projecting the activities selected by the user into corresponding schedule slots of the student schedule comprises:
projecting an activity into a corresponding schedule slot of the student schedule when the activity is selected by the user from the list of activities; and
displaying an extended description of the activity in the activities box.

20. The medium of claim 19 further comprises:
identifying activities in the list of activities with dates in a time interval selected by the user or in a time interval associated with a schedule slot selected by the user; and
displaying the activities that match the time interval selected by the user or time interval of the schedule slot selected by the user in the activities box.

21. The medium of claim 15 wherein completing registration of activities in the student schedule of activities with the enrichment providers comprises:
displaying a checkout window in the web browser, the checkout window displaying the activities added the student schedule;
computing total price of activities added to the student schedule;
displaying a notification that the total price is greater than the maximum price and returning to the second graphical user interface, when the user has provided a maximum price; and
registering the student with each enrichment provider that offers the activities added to the student schedule.
